(19) United States
(12) Patent Application Publication
(10) Pub. No.: US 2019/0376445 A1
(43) Pub. Date: Dec. 12, 2019

(54) HEAT ENGINE PROVIDED WITH AN IMPROVED SYSTEM FOR VARYING THE COMPRESSION RATIO

(71) Applicant: GOMECSYS B.V., Naarden (NL)

(72) Inventors: Matthieu Pogam, Chatou (FR); Julien Berger, Paris (FR); Lambertus Hendrik De Gooijer, Bussum (NL); Willem-Constant Wagenvoort, Huizen (NL); Sander Wagenaar, Huizen (NL)

(21) Appl. No.: 16/308,209

(22) PCT Filed: Jun. 2, 2017
(86) PCT No.: PCT/EP2017/063494

§ 371 Date: Aug. 22, 2019

(30) Foreign Application Priority Data
Jun. 9, 2016 (FR) 1655307

(51) Int. Cl. F02B 75/04; F02D 15/02

(52) U.S. Cl. CPC F02B 75/048; F16C 3/28; F02D 15/02

(57) ABSTRACT

A heat engine includes a system for varying compression ratio, which comprises
a crankshaft including at least a crank pin and an arm, and an eccentric part rotatably mounted on the crank pin. The eccentric part includes an eccentric outer surface intended for engaging with one end of a connecting rod and one toothed ring gear. A control device controls the angular position of the eccentric part. The control device includes an actuating shaft provided with an actuating pinion, at least one intermediate shaft passing axially, from side to side, through a journal and the arm of said crankshaft via a corresponding bore. The intermediate shaft is provided with a first intermediate pinion meshing with said actuating pinion and a second intermediate pinion meshing with an eccentric part.

### CROSS-REFERENCE TO RELATED APPLICATION

The present application is a national stage of International Patent Application Serial No. PCT/EP2017/063494, filed Jun. 2, 2017, and published in French.

### BACKGROUND

The present invention relates to a heat engine provided with an improved system for varying compression ratio. The invention has a particularly advantageous, but not exclusive, application in the field of motor vehicles.

Systems for varying compression ratio as a function of operating conditions of the engine are known. These systems for varying compression ratio comprise a set of eccentric parts which are mounted on the crankshaft crankpins such that each of them cooperate with an end of a connecting rod.

A control device makes it possible to adjust the position of the eccentric parts. For this purpose, the control device comprises an actuating shaft and a cascade of pinions constituted by an actuating pinion which is attached to the actuating shaft, and intermediate pinions of which a portion meshes with the actuating pinion, on the one hand, and another portion with a gear which is attached to the eccentric part, on the other hand.

At a fixed ratio or fixed actuating shaft with respect to the crankcase, each eccentric part rotates at half speed of the crankshaft. For this purpose, a meshing triplet is used between actuating pinions, intermediate pinions, and eccentric parts. The number of teeth of the actuating pinion being half as small as that of the eccentric parts, which allows a rotation of the first eccentric part located on the side of the half-speed actuation of that of the crankshaft at fixed ratio. The assembly of the pinions and transfer shafts at the level of the crankshaft journals allows, step by step, to transmit the kinematics of the first eccentric part located on the actuating side to the other eccentric parts.

According to a first configuration described in document WO2013110700, the gear triplet of the actuating pinion, the intermediate pinion, and the eccentric part extend in different planes. This requires digging locally the arm of the crankshaft to integrate the intermediate pinion. Such a configuration has the disadvantage of mechanically weaken the crankshaft.

A second known configuration is distinguished by the fact that the gear triplet of the actuating pinion, the intermediate pinion, and the eccentric part extend in the same plane. A compromise between functional, crankshaft strength, crank radius, and teeth strengths may allow that the sum of the head radius of the teeth of the actuating pinion and of the eccentric part is smaller than the crank radius of the crankshaft. This can improve the crankshaft strength, as there is no need to dig the crankshaft arm for integration of the assembly. The strength of the teeth is, however, reduced with respect to the above-mentioned first configuration.

### SUMMARY

A heat engine, particularly of a motor vehicle, includes a system for varying a compression ratio of the engine, the system for varying the compression ratio comprising:

a crankshaft comprising, at least a crankpin and at least an arm,

at least an eccentric part rotatably mounted on the crankpin, the eccentric part having an external face of eccentric shape intended for cooperating with an end of a connecting rod, as well as at least a gear, and

a control device for controlling the angular position of the eccentric part,

wherein that the control device includes:

an actuating shaft provided with an actuating pinion, and

at least an intermediate shaft passing axially through a journal and the arm of the crankshaft by a corresponding bore, the intermediate shaft being provided with a first intermediate pinion which meshes with the actuating pinion and with a second intermediate pinion which meshes with an eccentric part.

This aspect of the invention thus makes it possible to facilitate the integration of the system for varying compression ratio by creating a through-hole in the crank arm and no radial recesses that are difficult to machine, as was the case in the first configuration. This aspect of the invention also improves the rigidity of the assembly. In addition, the stresses applied to the teeth are less than in the second configuration, which maximizes torque that is transmitted by the control system.

According to one embodiment, the heat engine includes two intermediate shafts which are each provided with a first intermediate pinion which meshes with the actuating pinion and a second intermediate pinion which meshes with an eccentric part. This makes it possible to distribute the torque transmitted by the intermediate shafts.

According to one embodiment, the actuating shaft is coaxial with the crankshaft, wherein the two intermediate shafts are positioned on either side of the actuating shaft.

According to one embodiment, at least a bearing is interposed radially between an intermediate shaft and a face of the corresponding bore.

According to one embodiment, the heat engine comprises a crankcase in which are inserted at least partially the intermediate shaft(s).

According to one embodiment, the crankcase comprises at least a chamber forming a bearing for rotatably mounting an end of a corresponding intermediate shaft.

According to one embodiment, the crankcase incorporates a pinion at the outer periphery.

According to one embodiment, a pulley is fixed on an axial end face of the crankcase.

According to one embodiment, each first intermediate pinion is integrated with a corresponding intermediate shaft.

According to one embodiment, a speed ratio between the rotational speed of the eccentric part divided by the rotational speed of the actuating pinion is equal to 0.5.

### BRIEF DESCRIPTION OF THE DRAWING

Aspects of the invention will be better understood on reading the following description and on examining the accompanying figures. These figures are only given for illustrative reasons, but they are not limiting the invention.

FIG. 1 is an overall view of a system for varying compression ratio integrated in a crankshaft of a heat engine;

FIG. 2 is a longitudinal sectional view of the crankshaft and the system for varying compression ratio;

FIG. 3 is a perspective view of the system for varying compression ratio;

FIG. 4 is an exploded perspective view of the actuating device of the system for varying compression ratio;

FIG. 5 is a longitudinal sectional view illustrating an alternative embodiment of the system for varying compression ratio;

FIG. 6 is a perspective view of the end of the crankshaft incorporating the actuating device;

FIGS. 7a, 7b, and 7c are schematic representations illustrating different gear combinations for obtaining a reduction ratio of 0.5 between the actuating pinion and the eccentric part.

### DETAILED DESCRIPTION OF THE ILLUSTRATIVE EMBODIMENT

Identical, similar or analogous elements have the same reference from one figure to another.

FIG. 1 shows a crankshaft 12 incorporating a system 11 for varying the compression ratio as a function of the operating conditions of the engine. The system 11 thus makes it possible to operate an internal combustion engine at a high compression ratio under low load conditions in order to improve its efficiency. Under high load operating conditions, the compression ratio can be decreased to avoid knocking.

More specifically, the crankshaft 12 including axis X is intended to be rotatably mounted on a motor crankcase through bearings. The crankshaft 12 comprises a plurality of crankpins 13 and journals 14 which cooperate with the crankcase bearings. The crankpins 13 and the journals 14 are separated by arms 17 extending substantially perpendicular to the axis X. The crankshaft 12 further has a front end intended to be attached in rotatable direction with a pulley 18. A flywheel (not shown) is attached in rotatable direction to the rear end of the crankshaft 12.

Eccentric parts 21 are rotatably mounted on the crankpins 13 via a through-hole 22 made in each eccentric part 21. Each eccentric part 21 has an outer face 25 of eccentric shape with respect to the axis of the hole 22 and thus the corresponding crankpin 13. The outer face 25 is intended to cooperate with a big end of a connecting rod (not shown), which has its small end rotationally connected to a piston of the engine. Each eccentric part 21 also comprises two gears 28 positioned on either side of the outer face 25.

The eccentric parts 21 may be monobloc parts. In this case, the crankshaft 12 is subdivided into several parts to allow installing of the assembly. Alternatively, the crankshaft 12 is a monobloc, while the eccentric parts 21 are formed of two half-shells which are mounted around each crankpin 13.

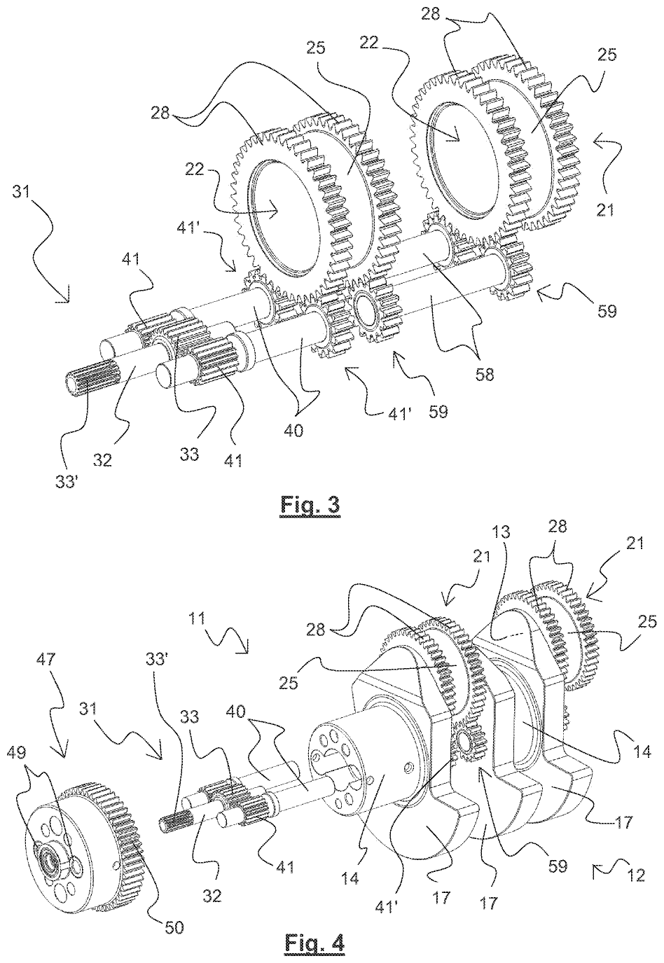

A control device 31 makes it possible to adjust the angular position of the eccentric parts 21, as shown in FIGS. 3 and 4.

For this purpose, the control device 31 comprises an actuating shaft 32 provided with an actuating pinion 33, the other end being provided with a pinion 33′ intended to cooperate with an actuating device regulating the angular position of the eccentric parts 21.

In addition, two intermediate shafts 40 pass axially right through a journal 14 and an arm 17 of the crankshaft 12 by a corresponding bore 43. Each intermediate shaft 40 is provided with a first intermediate pinion 41 meshing with the actuating pinion 33 and a second intermediate pinion 41′ meshing with an eccentric part 21. The actuating pinion 33 and the eccentric part 21 are positioned on either side of the arm 17 of the crankshaft 12.

The actuating shaft 32 is advantageously coaxial with the crankshaft 12, while the two intermediate shafts 40 are positioned on either side of the actuating shaft 32.

To ensure rotational guidance of the intermediate shafts 40 inside the journal 14, a bearing 44, for example of the needle type, is interposed radially between each intermediate shaft 40 and a face of the corresponding bore 43.

In an exemplary embodiment, the first pinions 41 are integrated at one end of a corresponding intermediate shaft 40. The pinions 41 may be obtained by machining or forging the intermediate shaft 40. The second pinions 41′ can be fitted on the side of the opposite end of the corresponding shaft 40.

Furthermore, the control system 31 comprises a canister 47, shown in FIGS. 4 and 6, in which the intermediate shafts 40 are at least partly inserted. For this purpose, the canister 47 comprises two chambers 49 each forming a bearing for rotational mounting an end of a corresponding intermediate shaft 40. Bearings 55, for example of the needle type, may be interposed radially between the inner face of the chamber 49 and the corresponding intermediate shaft 40.

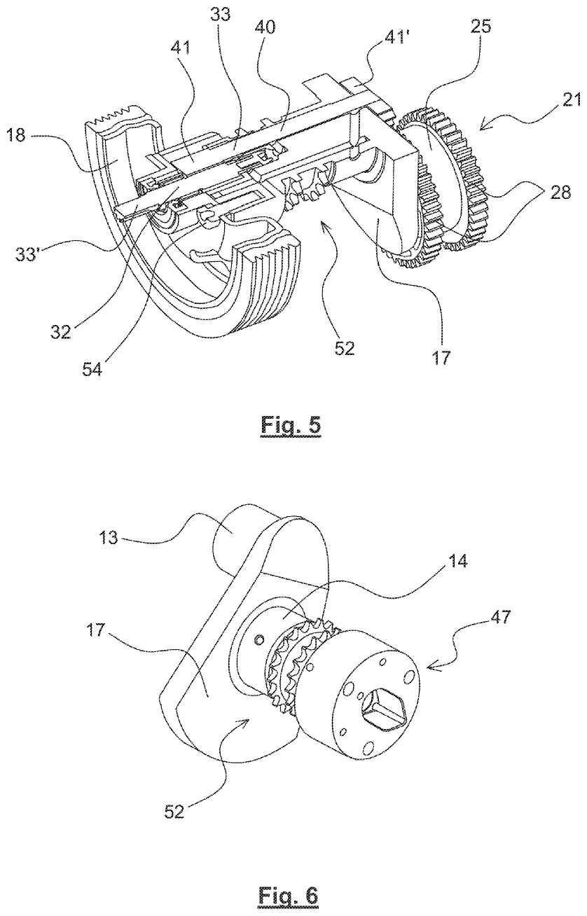

The canister 47 may incorporate a pinion 50 at the outer periphery. This pinion 50 may for example be used by the oil circuit. It will be possible to provide teeth 52 for the transmission train that is visible in FIGS. 5 and 6. These teeth 52 are interposed axially between the canister 47 and the journal 14 of the crankshaft 12. The teeth 52 may be made in one piece with the journal 14 or mounted with respect to the journal 14.

The pulley 18 is fixed on an axial end face of the canister 47. The pulley 18 may for example be fixed to the canister 47 by means of a set of screws 54 passing through a transverse wall of the pulley 18 to cooperate with threaded openings made in the canister 47, as shown in FIG. 5. Other fastening systems of the pulley 18 on the canister 47 are however conceivable.

According to an alternative embodiment illustrated in FIG. 5, the control device comprises a single intermediate shaft 40. However, the use of two intermediate shafts 40 or more makes it possible to reduce the torque supported by each intermediate shaft 40.

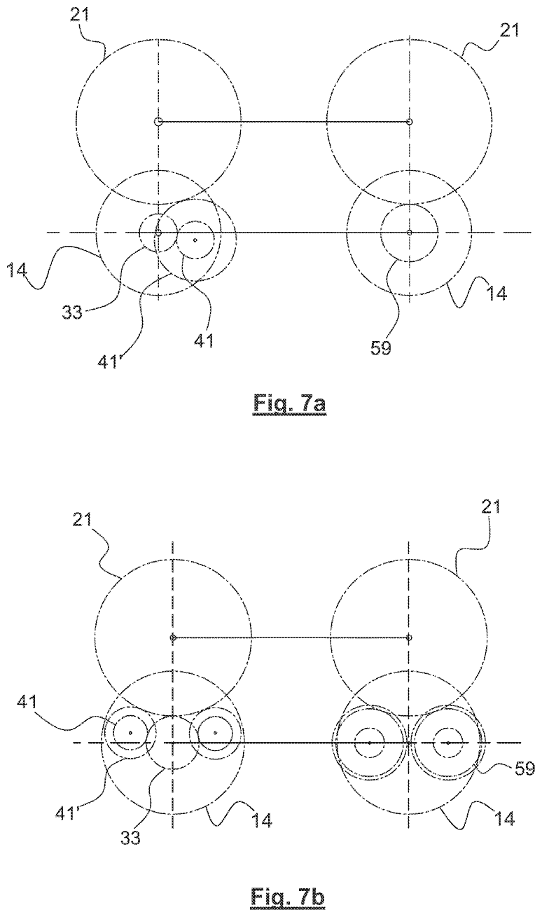

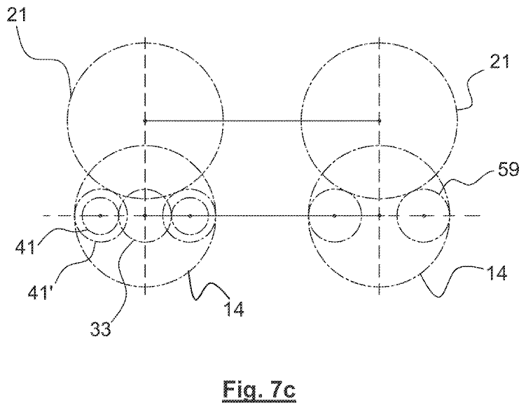

A speed ratio between the rotational speed of the eccentric part 21 divided by the rotational speed of the actuating pinion 33 is equal to 0.5. As shown in FIG. 7a, this ratio may for example be obtained directly between the eccentric part 21 and the second intermediate pinion 41′ that mesh with each other. For this purpose, it will be possible to use an actuating pinion 33 having 15 teeth with a module of 1, a first and a second intermediate pinion 41, 41′ comprising 15 teeth with a module of 1 and 22 teeth with a module of 1.5, respectively, and an eccentric part 21 having 44 teeth with a module of 1.5. The transfer pinion 59 comprises for example 15 teeth with a module of 1.5 and the corresponding eccentric part 21 has 44 teeth with a module of 1.5.

FIGS. 7b and 7c show the same configuration on the actuating side, but the crank radius, corresponding to the distance between the center of the crankpin 13 and the center of the journal 14, being shorter for the configuration of FIG. 7c, and the transfer pinions 59 are smaller for the configuration of FIG. 7c than for the configuration of FIG. 7b. In an exemplary embodiment, an actuating pinion 33 having 22 teeth with a module of 1, intermediate pinions 41, 41′ having 15 teeth, and an eccentric piece 21 having 44 teeth are used. In this case, there is provided a first intermediate pinion 41 meshing with the actuating pinion 33 having a module of 1 and a second intermediate pinion 41′ meshing with an eccentric part 21 having a module of 1.5. In the embodiment of FIG. 7b, the transfer pinion 59 comprises, for example, 19 teeth with a module of 1.5 and the corresponding eccentric part 21 has 44 teeth with a module of 1.5. In the embodiment of FIG. 7c, the transfer gear 59 comprises, for example, 15 teeth with a module of 1.5 and the eccentric part 21 has 44 teeth with a module of 1.5. Other configurations of intermediate pinions 41, 41′ and eccentric parts 21 are of course conceivable to obtain the desired reduction ratios of the system.

In operation and when the actuating shaft 32 is fixed in rotational direction with respect to the frame, the system 11 has a fixed compression ratio configuration. In transient rate, the angular position of the eccentric part 21 located on the side of the pulley 18 is controlled by the angular position of the actuating shaft 32 in order to turn to a new compression ratio point. For this purpose, the shaft 32 may be actuated for example by means of the actuating device, such as a wheel and worm gear or any other means for moving the adapted shaft.

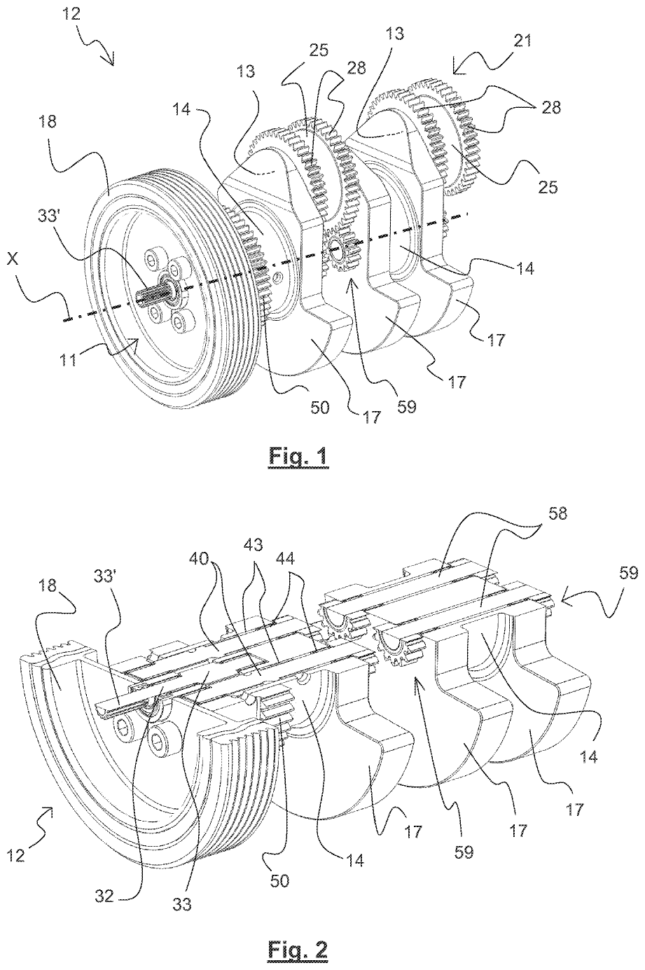

In addition, as illustrated in FIGS. 2 and 4, through the journals 14 of the crankshaft 12, shafts 58 and so-called transfer pinions 59 transmit the same kinematics of the eccentric part 21 located on the side of the actuating shaft 32 step by step on all the other eccentric parts 21 of the crankshaft 12. To this end, the pinions 59 mounted on the shafts 58 mesh with the gears 28 of the other eccentric parts 21.

The invention thus facilitates the integration of the system 11 of variation of the compression ratio by the embodiment of through-hole 43 in the crank arm 12 and no radial recesses which are difficult to machine, as was the case in the first configuration. The invention also improves the rigidity of the assembly. In addition, the stresses applied to the teeth are less than in the second configuration, which makes it possible to maximize the torque transmitted by the control system 31.

1. A heat engine, in particular of a motor vehicle, comprising a system for varying a compression ratio of said engine, said system for varying the compression ratio comprising:
a crankshaft comprising, at least a crankpin and at least an arm,
at least an eccentric part rotatably mounted on said crankpin, said eccentric part having an external face of eccentric shape intended for cooperating with an end of a connecting rod, as well as at least a gear, and
a control device
comprising:
an actuating shaft provided with an actuating pinion, and
at least an intermediate shaft passing axially through a journal and said arm of said crankshaft by a corresponding bore, said intermediate shaft being provided with a first intermediate pinion which meshes with said actuating pinion and with a second intermediate pinion which meshes with an eccentric part.

2. The heat engine according to claim 1, wherein said at least the intermediate shaft comprises two intermediate shafts each provided with a first intermediate pinion which meshes with said actuating pinion and a second intermediate pinion which meshes with an eccentric part.

3. The heat engine according to claim 2, wherein said actuating shaft is coaxial with said crankshaft, wherein said two intermediate shafts are positioned on either side of said actuating shaft.

4. The heat engine according to claim 2, wherein at least a bearing is interposed radially between an intermediate shaft and a face of said corresponding bore.

5. The heat engine according to claim 1, and further comprising a canister in which are inserted at least partially said intermediate shaft.

6. The heat engine according to claim 5, wherein said canister comprises at least a chamber forming a bearing for rotatably mounting an end of a corresponding intermediate shaft.

7. The heat engine according to claim 5, wherein said crankcase incorporates a pinion at an outer periphery.

8. The heat engine according to claim 5, and further comprising a pulley fixed on an axial end face of said crankcase.

9. The heat engine according to claim 5, wherein each first intermediate pinion is integrated with a corresponding intermediate shaft.

10. The heat engine according to claim 5, wherein a speed ratio between the rotational speed of said eccentric part divided by the rotational speed of said actuating pinion is equal to 0.5.
